(19) United States
(12) Patent Application Publication
(10) Pub. No.: US 2022/0403667 A1
(43) Pub. Date: Dec. 22, 2022

(54) ANTI-SLIP APPARATUS, TEMPLATE THEREFOR AND METHOD OF MANUFACTURE THEREOF

(71) Applicant: EVERGRIP LIMITED, YORKSIRE (GB)

(72) Inventor: Nick OSBORNE, YORKSIRE (GB)

(21) Appl. No.: 17/753,879

(22) PCT Filed: Sep. 11, 2020
(86) PCT No.: PCT/GB2020/052204

§ 371 Date: Mar. 16, 2022

(30) Foreign Application Priority Data
Sep. 16, 2019 (GB) 1913331.3

(51) Int. Cl. E04F 15/02; B29C 70/28; B29C 70/64; E04F 15/10

(52) U.S. Cl. CPC E04F 15/02172; B29C 70/28; B29C 70/64; E04F 15/0215; E04F 15/102; E04F 15/105; B29K 2067/00

(57) ABSTRACT

The present invention provides an anti-slip apparatus. The apparatus forms a planar, layered member and includes a glass-reinforced plastic (GRP) layer, a first resin layer, an abrasive or anti-slip material layer, and a second, top resin layer. Also provided is a template apparatus arranged to enable the installation/application to a floor or surface of an anti-slip apparatus as herein described.

The invention to which this application relates is an anti-slip apparatus, a template therefore and a method of manufacture thereof.

Anti-slip products are well known and there are several popular solutions available. Typically, an anti-slip product will be required and applied to improve the grip of tools, equipment or machinery and, more commonly, to improve the safety of floors or surfaces where people may stand or walk and which otherwise may become slippery and thus hazardous in certain circumstances. For example, such product may range from applications into baths or shower trays to prevent a user from slipping therein. They may also be placed in indoor or outdoor areas where people may commonly walk and which can become slippery when wet. One solution is the provision of adhesive anti-slip tape, which comprises an upper anti-slip layer formed from an abrasive material, and a lower thin adhesive layer enabling the tape to stick to a surface when applied thereto. The anti-slip layer is however, essentially an amount of small particles or grit applied to a top-side of double-sided adhesive tape. The grit is not encased, and the anti-slip nature of the tape relies on the ability of the tape alone to hold the particles/grit in position. Consequently, the longevity of the anti-slip tape is limited, and such tape is generally a temporary solution and may be used more to improve a user's grip on tools or equipment they require. The thin adhesive layer makes the tape difficult to use below certain temperatures as the adhesive may usually only be applied at a minimum temperature of about 10° C. Furthermore, since the product is formed as a tape, the abrasive layer—usually a grit such as quartzite—is restricted in its “hardness” and thus its effectiveness and durability.

Less commonly, anti-slip products are sometimes sold as thin, circular discs formed from a vinyl material, usually PVC, and which have an abrasive material or grit applied to a top surface, and a thin adhesive layer on the bottom surface. Such discs are provided to be easily used and applied to a surface by a user and may also be cut to size owing to the relatively soft material used. Once again, the problem with such products is the anti-slip material used does not necessarily have an optimum hardness and the overall longevity and durability of the product is limited.

Another anti-slip disc is provided as a stainless-steel disc, with an abrasive top surface. However, application of these discs onto a surface can be very labour intensive as the adhesive needed for use has to be applied by the user upon installation, or mechanically fixed in place.

Moreover, when installing the anti-slip discs, it is often desirable to do so in an aesthetically pleasing and efficient pattern. This requires the user to measure very precise distances and angles between individual discs and once again, is very labour intensive and time consuming.

It is therefore an aim of the present invention to provide an improved anti-slip apparatus which overcomes the problems associated with the aforementioned prior art.

It is a further aim of the present invention to provide a means by which to efficiently apply and/or install improved anti-slip apparatus which overcomes the problems associated with the aforementioned prior art.

It is yet a further aim of the present invention to provide a method of manufacturing an improved anti-slip apparatus which overcomes the problems associated with the aforementioned prior art.

According to a first aspect of the invention there is provided an anti-slip apparatus, said apparatus forming a planar, layered member and including:

a glass-reinforced plastic (GRP) layer;

a first resin layer;

an abrasive or anti-slip material layer; and

a second, top resin layer.

Typically, said apparatus further includes an adhesive, bottom layer, bonded to an underside of said GRP layer. In one embodiment, said adhesive layer is formed integrally to said GRP layer. In another embodiment, said adhesive layer may be applied subsequently to the GRP layer, in use.

Typically, said abrasive or anti-slip layer is located between said first and second resin layers.

Typically, said glass-reinforced plastic is provided as fibreglass.

In one embodiment, said first resin layer forms a gel coat layer and said second, top resin layer forms a flo coat layer. Typically, the resin provided to form said first and second resin layers is a polyester resin. Preferably, said first and second resin layers are provided to bond the abrasive or anti-slip layer. Such bonding thus creates a substantially homogenous amalgamation of the upper three layers of the apparatus. This removes or substantially reduces the risk of flaking, peeling and delamination of the apparatus, thereby increasing its durability and longevity.

In one embodiment, the second resin layer may further include a UV stabilizer incorporated therein.

Preferably, said abrasive or anti-slip layer is formed from aluminium oxide (Al₂O₃). Said aluminium oxide may be otherwise known as alumina, corundum, or polymorphic phase aluminium oxide. In alternative embodiments, said anti-slip layer may be formed from other minerals such as quartzite or, in other embodiments, a mixture of two or more different minerals or materials.

In one embodiment, said anti-slip layer is provided as aluminium oxide particles. Typically, said particles are spread in a substantially even distribution over and across the first resin layer. Further typically, said second resin layer is provided to encase said aluminium oxide particles.

Aluminium oxide is a preferred substance to be used for the anti-slip layer as it is one of the toughest and strongest substances available, measuring between 9-9.5 on the mohs scale of mineral hardness (10 being diamond). The use of aluminium oxide thus ensures the longevity and durability of the apparatus according to the invention is maximised. Furthermore, aluminium oxide is transparent in nature and therefore enables the apparatus to be formed in any colour as so desired by a user or the manufacturer.

The present invention therefore provides a novel anti-slip apparatus with far superior abrasive/toughness properties than those anti-slip products currently available. The durability of the apparatus of the present invention is further improved by the provision of a GRP layer on which the anti-slip layer ultimately locates. Furthermore, by encasing the anti-slip layer in a resin, this shields it from direct exposure to the elements and thus serves to protect it from damage and/or degradation, unlike those anti-slip products which are currently available.

In one embodiment, the adhesive provided to form said adhesive layer may be an acrylic foam. In other embodiments, various other industrial adhesives may be utilised, depending on the specific requirements of the apparatus and the area in which it is to be located. Acrylic foam adhesives are preferably used as they are ideal for both indoor and outdoor use, and on both rough and smooth surfaces. For example, provision of such an adhesive would enable the apparatus to be used on stone, concrete, wood, ceramic, slate, marble, decking, vinyl and other such surfaces.

Typically, the bond created between the adhesive layer and the surface on which the apparatus is placed, in use, creates a semi-permanent bond.

Preferably, said adhesive layer is provided located on an underside of said GRP layer. With the adhesive layer already present on the apparatus, this ensures quick and easy use by a user as the apparatus is provided in a “ready to use” condition. This is in clear contrast to the harder wearing stainless steel anti-slip disc, wherein a polymer adhesive must be applied to the disc by a user prior to application of that disc to a surface.

Typically, said apparatus is provided for location on a floor or surface, in use. Said floor or surface may be indoor or outdoor.

In one embodiment, a plurality of said anti-slip apparatus may be provided to form an anti-slip path, area or region on a desired floor or surface, in use.

In one embodiment, said apparatus is provided as a planar panel. Typically, said panel is disc shaped. In other embodiments, said panel may be provided in a variety of shapes, as required by a user. Typically, said apparatus may be provided in varying sizes, as required by a user.

Typically, the apparatus may be provided in a range of different colours. Further typically, one or both of the resin layers may have a dye or colourant incorporated therein to provide a particular colour to the apparatus. Typically, said dye or colourant may be provided as a “high visibility” colour. As mentioned above, using aluminium oxide to form the abrasive or anti-slip layer can be advantageous because it is transparent, enabling the resin layers to be provided in a particular colour and not be inhibited by the anti-slip layer. In addition to this, the ability to provide the apparatus in a variety of shapes and sizes enables a user to customize the apparatus as they desire and provide it to be aesthetically pleasing, something which is not provided for in the prior art.

In some embodiments, the provision of the apparatus in one or more different colours can have the technical advantage of making the apparatus more visible to a person walking or standing in the vicinity of the apparatus, creating a “hi-vis” effect, which has obvious safety benefits in particularly slippery and/or darker settings.

In another aspect of the present invention, there is provided a template apparatus arranged to enable installation/application to a floor or surface of an anti-slip apparatus as described above.

In one embodiment, said template comprises an elongate, planar member having a plurality of apertures formed therethrough. Typically, said apertures are sized and shaped to match the dimensions of an anti-slip apparatus as described above.

In one embodiment, said plurality of apertures are provided in the template in a pattern or arrangement, which define a pattern or arrangement that the anti-slip apparatus will be applied to a desired floor or surface, in use. Typically, said pattern or arrangement may be predetermined or selected/created by a user. In such circumstances, however, the desired pattern, once selected/created by the user, would require engineering by the manufacturer to ensure optimum tread once in situ.

The provision of a template apparatus as described above serves to ensure precise and tidy alignment and installation of the anti-slip apparatus, in a set arrangement according to the needs of a user. The provision of such templates removes the labour-intensive measuring and positioning of each individual anti-slip disc or panel and ensures near-perfect alignment and optimum grip tread for maximum safety.

Typically, the template apparatus will be provided of a thickness substantially similar to that of an associated anti-slip apparatus.

In another aspect of the present invention, there is provided a combination of a plurality of anti-slip apparatus as described above, and an associated alignment template as described above, said template provided to enable installation/application to a floor or surface of said plurality of anti-slip apparatus, in use.

In another aspect of the present invention, there is provided a method of manufacturing an anti-slip apparatus, said method including the steps of:

providing a layer of glass-reinforced plastic (GRP);

applying a first coating or layer of resin to an upper side of the GRP layer;

applying a substantially even distribution of an anti-slip material or substance across the first layer of resin;

applying a second coating or layer of resin over the anti-slip material or substance, encasing the same within the resin; and

curing the layered materials in temperature-controlled conditions to form said anti-slip apparatus.

Typically, an adhesive layer is provided, bonded to an underside of the GRP layer. Typically, said adhesive layer is formed from an acrylic foam adhesive. In other embodiments, various other industrial adhesives may be utilised, depending on the specific requirements of the apparatus and the area in which it is to be located.

Preferably, said anti-slip material or substance is provided in the form of aluminium oxide particles.

Typically, said resin is a polyester resin.

Typically, the apparatus is formed in a range of different colours. Further typically, one or both of the resin layers may have a dye or colourant incorporated therein to provide a particular colour to the apparatus.

Embodiments of the present invention will now be described with reference to the accompanying figures, wherein:

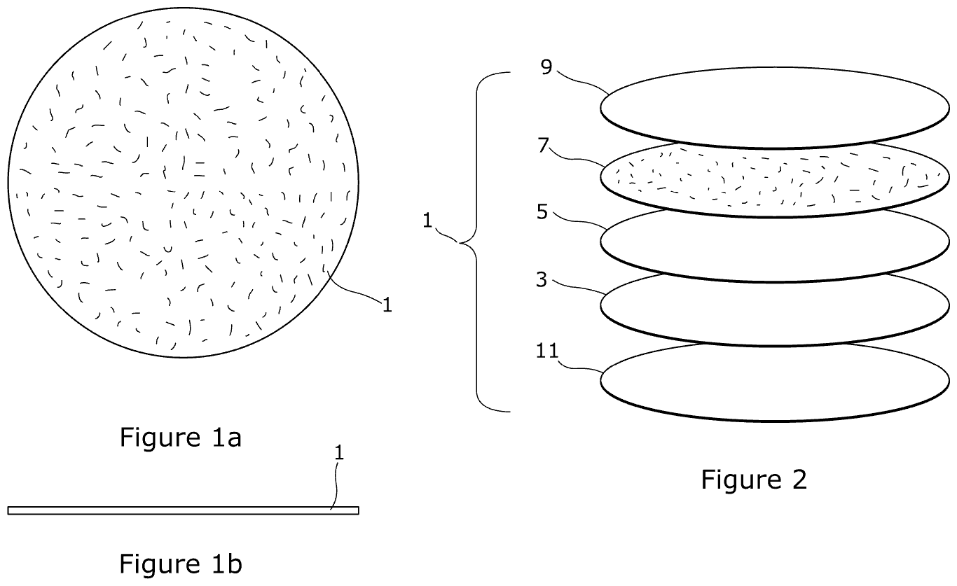

FIGS. 1a-b illustrate top and side-on views of an anti-slip apparatus in accordance with an embodiment of the present invention;

FIG. 2 illustrates an explodes view of an anti-slip apparatus, showing various layers thereof, in accordance with an embodiment of the present invention;

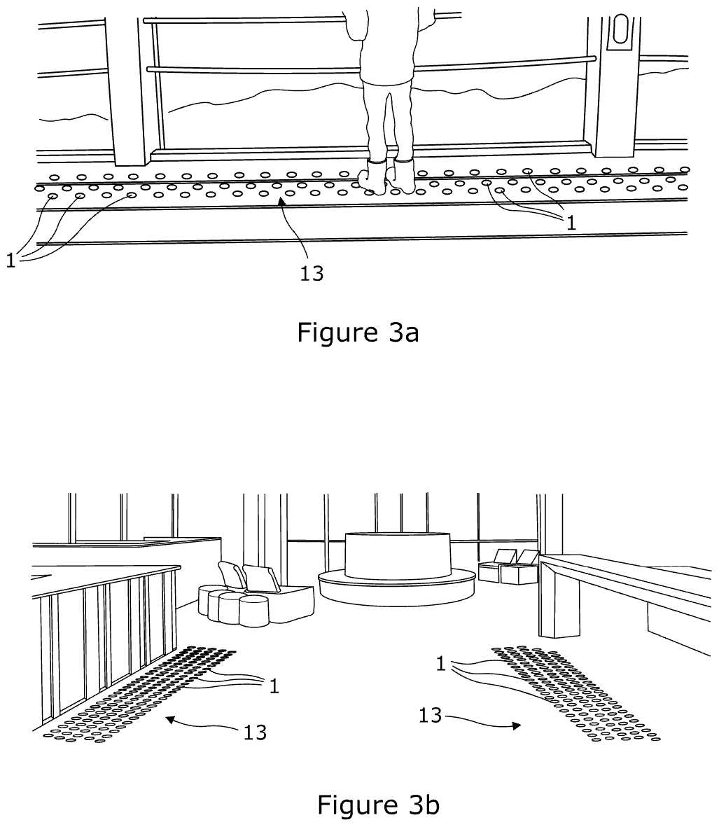

FIGS. 3a-b illustrate a plurality of anti-slip apparatus in use in indoor and outdoor environments, in accordance with an embodiment of the present invention; and

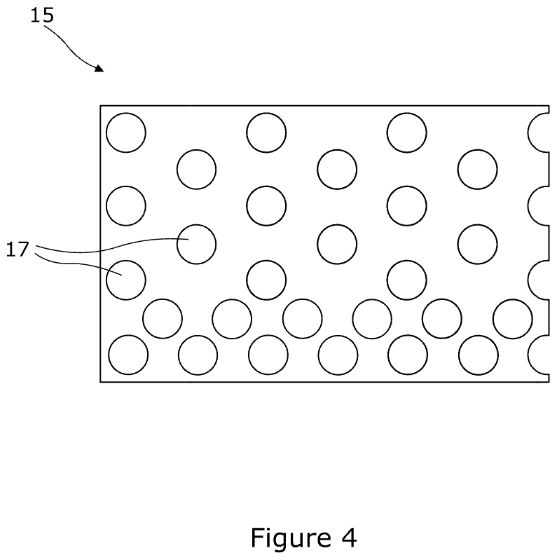

FIG. 4 illustrates a template apparatus for use in the installation and/or application of anti-slip apparatus, in accordance with an embodiment of the present invention.

Referring now to the figures, there is shown in FIGS. 1a-b an anti-slip apparatus in the form of an anti-slip disc 1. The disc 1 is provided to be placed on a floor or surface—indoor or outdoor—to improve the grip and thus safety for a user walking across the surface. Typically, a plurality of the discs 1 will be placed on the desired floor or surface, creating an anti-slip path, area or region thereon. The disc 1 is provided as a planar, layered body and, as shown in FIG. 2, comprises multiple layers bonded together. The main body of the disc 1 is formed from a glass-reinforced plastic (GRP)— commonly known as fibreglass—layer 3. A first layer 5 of resin is disposed on top of the GRP layer 3, a layer of abrasive or anti-slip material 7 is then located between the first resin layer 5 and a second, upper layer 9 of the resin, provided so as to encase the anti-slip material layer 7. The resin layers 5, 9 are generally formed from a polyester resin. These layers bond to form the basis of the anti-slip disc 1, and in preferred embodiments of the invention a further layer is also included: a bottom adhesive layer 11 bonded to the underside of the GRP layer 3. In other examples of the invention, the adhesive layer 11 may be applied subsequently to the GRP layer 3, for example, at the time when a user is about to apply/install the disc 1 on a floor or surface. The first resin layer 5 essentially forms a gel coat layer with the anti-slip material 7 disposed thereon, and the second resin layer 9 is subsequently provided to form a flo coat layer, and together they bond the anti-slip material layer 7. Such bonding thus creates a substantially homogenous amalgamation of the upper three layers of the disc 1. This removes or substantially reduces the risk of flaking, peeling and delamination of the disc 1, thereby increasing its durability and longevity. In addition, the second resin layer 9 may further include a UV stabilizer incorporated therein. This would be provided so as to prevent photo-degradation of the bonds within the resin and thus increasing its longevity.

The abrasive or anti-slip layer may be formed from a number of appropriate materials, however, preferred embodiments of the present invention form the layer 7 from aluminium oxide (Al₂O₃), which may be otherwise known as alumina, corundum, or polymorphic phase aluminium oxide. Typically, this is provided in the form of aluminium oxide particles which are spread over and across the first resin layer 5 in an even distribution. The second layer of resin 9 is then applied over the top of the aluminium oxide particles 7 to encase them. The bonded layers 3, 5, 7, 9, are then placed in a temperature-controlled room for curing and forming the disc 1. Aluminium oxide is a preferred substance to be used for the anti-slip layer as it is one of the toughest and strongest substances available, measuring between 9-9.5 on the mohs scale of mineral hardness (10 being diamond). This is in contrast to the abrasive materials used in the anti-slip discs or tapes currently available, wherein minerals such as quartzite are generally used and which have a mineral hardness of only about 6.5 on the mohs scale. The use of aluminium oxide thus ensures the longevity and durability of the disc 1 of the invention is maximised. Furthermore, aluminium oxide is transparent in nature and therefore enables the disc 1 to be formed in any colour as so desired by a user or the manufacturer. However, it will be appreciated that the present invention may in some embodiments be provided having an anti-slip layer 7 formed from other minerals such as quartzite or, in other embodiments, a mixture of two or more different minerals or materials (for example, a mixture of aluminium oxide and quartzite). Thus, there is provided a new anti-slip disc 1 having far superior abrasive/toughness properties than those anti-slip products currently available. The durability of the disc 1 of the present invention is further improved by the provision of a GRP layer 3 on which the anti-slip layer 7 ultimately locates. Furthermore, by encasing the anti-slip layer between resin layers 5, 7, this shields it from direct exposure to the elements and thus serves to protect it from damage and/or degradation, unlike those anti-slip products which are currently available.

As mentioned above, the adhesive layer 11 is preferably bonded to the underside of the GRP layer 3, but may in some examples be applied subsequently, i.e., just prior to use and application of the disc 1. With the adhesive layer 11 already present on the disc 1, this ensures quick and easy use by a user as the disc 1 is provided in a “ready to use” condition. The adhesive 11 is preferably provided as an acrylic foam adhesive. Acrylic foam adhesives are preferably used as they are ideal for both indoor and outdoor use, and on both rough and smooth surfaces. For example, provision of such an adhesive enables the disc 1 to be used on stone, concrete, wood, ceramic, slate, marble, decking, vinyl and other such surfaces. The bond which is subsequently created between the acrylic foam adhesive layer 11 and the surface on which the apparatus is placed creates a semi-permanent bond. They can also be applied at temperatures as low as −12° C., and will withstand a temperature range of −35° C.-100° C. in use. FIGS. 3a-b illustrate examples of a plurality of discs 1 according to the invention having been place in both outdoor and indoor locations, forming anti-slip areas or paths 13 for users to walk on or along. While the present description and figures refer to the anti-slip apparatus as being a disc-shaped body, it will be understood that the present invention may be provided in a variety of shapes and sizes as may be required by the user/installer of the apparatus.

The disc 1 may be provided in a range of different colours as is desired by the user. This can be achieved by incorporating a dye or colourant into one or both of the resin layers 5, 9 to provide a particular colour to the disc 1. The dye or colourant may be provided as a “high visibility” colour. As mentioned above, using aluminium oxide to form the abrasive or anti-slip layer 7 can be advantageous because it is transparent, enabling the resin layers 5, 9 to be provided in a particular colour and not be inhibited by the anti-slip layer 7. In addition to this, the ability to provide the apparatus in a variety of shapes and sizes (as opposed to simply the disc 1 as illustrated in the Figures) enables a user to customize the apparatus as they desire and provide it to be aesthetically pleasing, something which is not provided for in the prior art. The provision of the apparatus in one or more different colours can have the technical advantage of making it more visible to a person walking or standing in the vicinity of the apparatus, creating a “hi-vis” effect, which has obvious safety benefits in particularly slippery and/or darker settings.

Referring now to FIG. 4, there is provided an alignment template 15 which is used to enable installation/application of a plurality of the anti-slip discs 1 described above to a floor or surface. The template 17 is essentially an elongated planar member having a number of holes 17 located therein. The holes 17 are sized and shaped to match the profile and dimensions of the discs 1 that are to be applied to the surface, and are formed in a pattern or arrangement which ultimately define the pattern or arrangement in which the discs 1 will be applied to the surface. The pattern may be predetermined or, for some installations, can be selected/designed by a user and manufactured to that specification. In such circumstances, however, the desired pattern, once selected/created by the user, would require engineering by the manufacturer to ensure optimum tread once in situ. As the discs 1 of the present invention may be provided in varying shapes and sizes, so to may the holes 17 in the template 15. This can enable the application of quite intricate patterns and shapes of anti-slip apparatus if so desired by a user, and the provision of such an alignment template 15 serves to ensure precise and tidy alignment and installation of the anti-slip discs 1, according to the needs of a user. The provision of such templates 15 removes the labour-intensive measuring and positioning of each individual anti-slip disc or panel and ensures near-perfect alignment and optimum grip tread for maximum safety.

1. An anti-slip apparatus, said apparatus forming a planar, layered member and including:
a glass-reinforced plastic (GRP) layer;
a first resin layer;
an abrasive or anti-slip material layer; and
a second, top resin layer.

2. An apparatus according to claim 1, wherein said apparatus further includes an adhesive, bottom layer, bonded to an underside of said GRP layer.

3. An apparatus according to claim 2, wherein said adhesive layer is formed integrally to said GRP layer.

4. An apparatus according to claim 2, wherein said adhesive layer is applied subsequently to the GRP layer, in use.

5. An apparatus according to claim 1, wherein said abrasive or anti-slip layer is located between said first and second resin layers.

6. An apparatus according to claim 1, wherein said glass-reinforced plastic is provided as fibreglass.

7. An apparatus according to claim 1, wherein said first resin layer forms a gel coat layer and said second, top resin layer forms a flo coat layer.

8. An apparatus according to claim 1, wherein the resin provided to form said first and second resin layers is a polyester resin.

9. An apparatus according to claim 1, wherein said first and second resin layers are provided to bond the abrasive or anti-slip layer, creating a substantially homogenous amalgamation of the first resin layer, abrasive or anti-slip layer, and the second resin layer.

10. An apparatus according to claim 1, wherein the second resin layer further includes a UV stabilizer incorporated therein.

11. An apparatus according to claim 1, wherein said abrasive or anti-slip layer is formed from aluminium oxide (Al₂O₃).

12. An apparatus according to claim 1, wherein said anti-slip layer is formed from minerals such as quartzite, or a mixture of two or more different minerals or materials.

13. An apparatus according to claim 1, wherein said anti-slip layer is provided as aluminium oxide particles.

14. An apparatus according to claim 13, wherein said particles are spread in a substantially even distribution over and across the first resin layer.

15. An apparatus according to claim 14, wherein said second resin layer is provided to encase said aluminium oxide particles.

16. An apparatus according to claim 2, wherein the adhesive provided to form said adhesive layer comprises an acrylic foam or other industrial adhesives.

17. An apparatus according to claim 2, wherein the bond created between the adhesive layer and a surface on which the apparatus is placed, in use, creates a semi-permanent bond.

18. An apparatus according to claim 1, wherein a plurality of said anti-slip apparatus is provided to form an anti-slip path, area or region on a desired floor or surface, in use.

19. An apparatus according to claim 1, wherein said apparatus is provided as a planar panel.

20. An apparatus according to claim 19, wherein said panel is provided in a variety of shapes and/or sizes, as required by a user.

21. An apparatus according to claim 1, wherein the apparatus is provided in a range of different colours.

22. An apparatus according to claim 1, wherein one or both of the resin layers have a dye or colourant incorporated therein to provide a particular colour to the apparatus.

23. A template apparatus arranged to enable installation/application to a floor or surface of an anti-slip apparatus according to any of claims 1-22.

24. A template apparatus according to claim 23, wherein said template comprises an elongate, planar member having a plurality of apertures formed therethrough, said apertures being sized and shaped to match the dimensions of an anti-slip apparatus according to any of claims 1-22.

25. A template apparatus according to claim 24, wherein said plurality of apertures is provided in the template in a pattern or arrangement, which define a pattern or arrangement that the anti-slip apparatus will be applied to a desired floor or surface, in use.

26. A combination of a plurality of anti-slip apparatus according to any of claims 1-22, and an associated alignment template according to any of claims 23-25, said template provided to enable installation/application to a floor or surface of said plurality of anti-slip apparatus, in use.

27. A method of manufacturing an anti-slip apparatus, said method including the steps of:
providing a layer of glass-reinforced plastic (GRP);
applying a first coating or layer of resin to an upper side of the GRP layer;
applying a substantially even distribution of an anti-slip material or substance across the first layer of resin;
applying a second coating or layer of resin over the anti-slip material or substance, encasing the same within the resin; and
curing the layered materials in temperature-controlled conditions to form said anti-slip apparatus.

28. A method according to claim 27, wherein an adhesive layer is provided, bonded to an underside of the GRP layer.

29. A method according to claim 27, wherein said adhesive layer is formed from an acrylic foam adhesive or other industrial adhesives.

30. A method according to claim 27, wherein said anti-slip material or substance is provided in the form of aluminium oxide particles.

31. A method according to claim 27, wherein said resin is a polyester resin.
